(19) United States
(12) Patent Application Publication
(10) Pub. No.: US 2005/0133662 A1
(43) Pub. Date: Jun. 23, 2005

(54) Convertible aircraft provided with two tilt fans on either side of the fuselage and with a third tilt fan arranged on the tail of the aircraft

(76) Inventor: Eric Magre, Pelissanne (FR)

Correspondence Address: YOUNG & THOMPSON, 745 SOUTH 23RD STREET, 2ND FLOOR, ARLINGTON, VA, 22202, US

(21) Appl. No.: 11/016,763

(22) Filed: Dec. 21, 2004

(30) Foreign Application Priority Data
Dec. 23, 2003 (FR) 03 15240

(51) Int. Cl. B64C 27/22

(52) U.S. Cl. 244/7 R

(57) ABSTRACT

The present invention provides a convertible aircraft provided with first and second tail booms together with first and second tilt fans disposed on either side of the fuselage a little forward of the center of gravity of said aircraft. In addition, the convertible aircraft includes, in remarkable manner, a third tilt fan arranged between the first and second tail booms.

The present invention relates to a convertible aircraft provided with tilting ducted rotors, commonly referred to as “tilt fans”, the aircraft being capable of taking off and landing over very short distances, or even vertically.

### BACKGROUND OF THE INVENTION

Numerous configurations have been attempted in the history of aviation to enable aircraft to take off and land vertically.

The helicopter configuration enables stationary flight to be performed under satisfactory control, but that is to the detriment of cruising speed. Research has thus been undertaken to improve hovering control of airplanes. Nevertheless, the solutions that have been found so far have been of moderate efficiency and have required complex modifications either to propulsion systems or to engines.

Document U.S. Pat. No. 5,054,716 discloses a convertible aircraft where each of the rotors together with its control and engine means constitutes a tilting assembly referred to as a “tilt rotor”. In that configuration, each engine must be capable of operating both in a substantially horizontal position and also in a vertical position, and that raises numerous problems associated either with the engine or with the cabling or the hydraulic and fuel ducts that need to pass through a tilting pivot. Furthermore, since the engines are generally turboengines, the gas jets from their nozzles have the drawback in helicopter mode of damaging the surface of take-off and landing areas.

Document U.S. Pat. No. 3,360,217 discloses a convertible aircraft having four tilt fans. In that configuration, the engines are disposed on the fuselage and remain in the same orientation regardless of the stage of flight. Passing from forward flight referred to as “airplane” mode to a helicopter mode is done by tilting the tilt fans only. Consequently, that makes it possible to avoid all problems associated with tilting an engine while it is running.

However, using four tilt fans is particularly penalizing insofar as the aircraft must have sufficient engine power to be capable of driving all four tilt fans. In addition, it goes without saying that the weight of the device is considerable, thereby correspondingly reducing the payload of the aircraft.

From those considerations, firstly it can be seen that the tilt rotor configuration is particularly difficult to implement and make suitable for industrial manufacture, because of the difficulties associated with tilting an engine. Secondly, it can be seen that the tilt fan configuration is easier to implement and does not present the above-described drawbacks, but that using four tilt fans increases the weight of the airplane in penalizing manner.

### OBJECTS AND SUMMARY OF THE INVENTION

An object of the present invention is to provide a convertible aircraft enabling the above-mentioned limitations to be overcome.

According to the invention, a convertible aircraft provided with first and second tail booms and with first and second tilt fans disposed on either side of its fuselage a little forward of the center of gravity of said aircraft, includes, in remarkable manner, a third tilt fan arranged between the first and second tail booms.

In order to maintain equilibrium while hovering, three fans are quite sufficient for providing a support polygon. The weight saved by omitting the fourth fan makes it possible significantly to increase the payload of the aircraft.

Advantageously the third tilt fan includes a first flap serving as a tail fin for the convertible aircraft.

In addition, the convertible aircraft advantageously includes two “canard” wings so as to be properly balanced.

In addition, the first, second, and third tilt fans are driven by only two engines arranged in the fuselage, the exhaust gases from these engines being exhausted from the top of the fuselage via two openings.

In a first embodiment, the convertible aircraft of the invention has two main wings that are sweptback, and that are disposed on either side of the fuselage, in the high position. It is explained below that each of these main wings is advantageously provided with double-slotted high-lift flaps and with a respective winglet, itself possessing a second flap. In this embodiment, the engines are located behind the cabin, and they are fed with air via two air intakes arranged in the sides of the fuselage.

In a second embodiment, the convertible aircraft has two main wings that are sweptforward, and that are disposed on either side of the fuselage, in the high position. Each of these main wings is advantageously provided with double-slotted high-lift flaps. In addition, first and second substantially horizontal tail stabilizers are respectively arranged on the first and second tail booms. Furthermore, in this particular embodiment, the engines are arranged in the fuselage above the cabin, and they are fed with air via two air intakes arranged on the top of the fuselage.

### BRIEF DESCRIPTION OF THE DRAWINGS

The invention and its advantages appear in greater detail in the following description of embodiments given by way of illustration with reference to the accompanying figures, in which:

FIG. 1 is a diagrammatic plan view of a convertible aircraft in a first embodiment;

FIG. 2 is a diagrammatic view of a convertible aircraft in a second embodiment;

FIG. 3 is a side view of a convertible aircraft of the first embodiment having its tilt fans in the vertical position;

FIG. 4 is a side view of a convertible aircraft of the second embodiment having its tilt fans in the vertical position;

FIG. 5 is a side view of a convertible aircraft in the first embodiment having is tilt fans in the horizontal position; and

FIG. 6 is a side view of a convertible aircraft in the second embodiment having its tilt fans in the horizontal position.

### MORE DETAILED DESCRIPTION

Elements that are present in more than one figure are given the same reference in all of them.

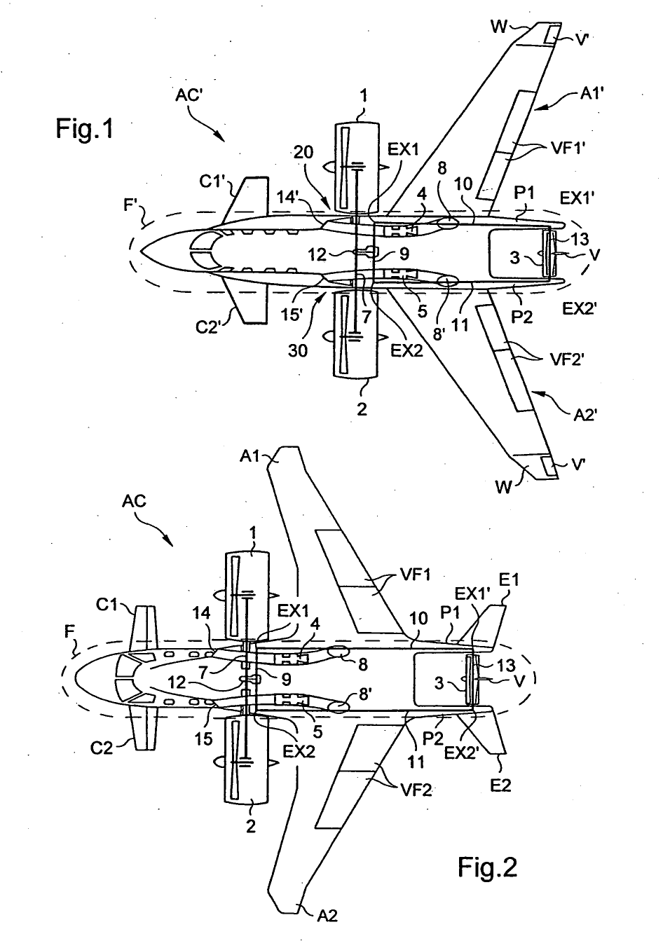

FIG. 1 shows a convertible aircraft AC′ constituting a first embodiment. This convertible aircraft AC′ has two engines 4, 5 located inside a fuselage F′, and provided with respective drive shafts 10, 11. Two air intakes 14′, 15′ respectively arranged in the sides 20, 30, of the fuselage F′ feed air to the engines 4 and 5. The exhaust gases from these engines 4, 5 are exhausted via two openings 8, 8′ disposed on top of the fuselage F, thus reducing its infrared signature when seen from the ground.

FIG. 2 shows a convertible aircraft AC constituting a second embodiment. This convertible aircraft AC has two engines 4, 5 disposed inside a fuselage F, and provided with respective drive shafts 10, 11. Two air intakes 14, 15 are arranged on top of the fuselage and feed the engines 4 and 5 with air. The exhaust gases from these engines 4, 5 are exhausted via two openings 8, 8′ disposed on top of the fuselage F, thus reducing its infrared signature when seen from the ground.

In addition, having two engines in these convertible aircraft AC, AC′ presents the advantage of being very safe, insofar as one of the engines breaking down will not significantly disturb the operation of the aircraft AC, AC′.

With reference to FIGS. 1 and 2, the first end EX1 of the drive shaft 10 and the first end EX2 of the drive shaft 11 are connected to a single interconnection shaft 9 inserted in the fuselage F, F′ via two distinct primary gear sets. As a result, the drive shafts 10 and 11 rotate a single interconnection shaft 9.

Similarly, the drive shafts 10 and 11 drive a single secondary transmission shaft 13 via two distinct secondary gear sets connected to the second ends EX1′ and EX2′ of the drive shafts 10, 11. This secondary transmission shaft 13 is arranged between the two tail booms P1, P2.

The blades of the third tilt fan 3, which fan is disposed between the two tail booms P1 and P2, are driven by the secondary transmission shaft 13. In addition, this third tilt fan 3 is advantageously fitted with a vertical first flap V serving as a tail fin for the convertible aircraft, and is capable of titling about said secondary transmission shaft 13.

Furthermore, a main transmission gearbox 12 disposed on the interconnection shaft 9 enables the blades of the first and second tilt fans 1 and 2 to be driven via a main transmission shaft 7.

The first and second tilt fans 1 and 2 are disposed one either side of the fuselage F, F′, a little forward of the center of gravity of the convertible aircraft AC, AC′. The first and second tilt fans 1 and 2 can tilt about the transmission shaft 7.

The locations of the first and second tilt fans 1 and 2 on the fuselage F, F′ of the convertible aircraft AC, AC′ correspond substantially to the position where the roots of the main wings are located on a conventional airplane of non-convertible type.

Consequently, the “tilt fan” configuration requires the main wings A1, A2, A1′, A2′ to be positioned on the rear portion of the fuselage F, F′. The aircraft AC, AC′ therefore cannot be properly controlled in pitch unless it possesses control surfaces at the front of the fuselage of the kind known in the aviation industry as “canard” wings C1, C2, C1′, C2′. The “canard” configuration is thus a direct consequence of the tilt fan configuration.

Furthermore, the trailing edges of the main wings A1, A2, A1′, A2′ are provided with respective high-lift flaps VF1, VF2, VF1′, VF2′ having two slots, or the like.

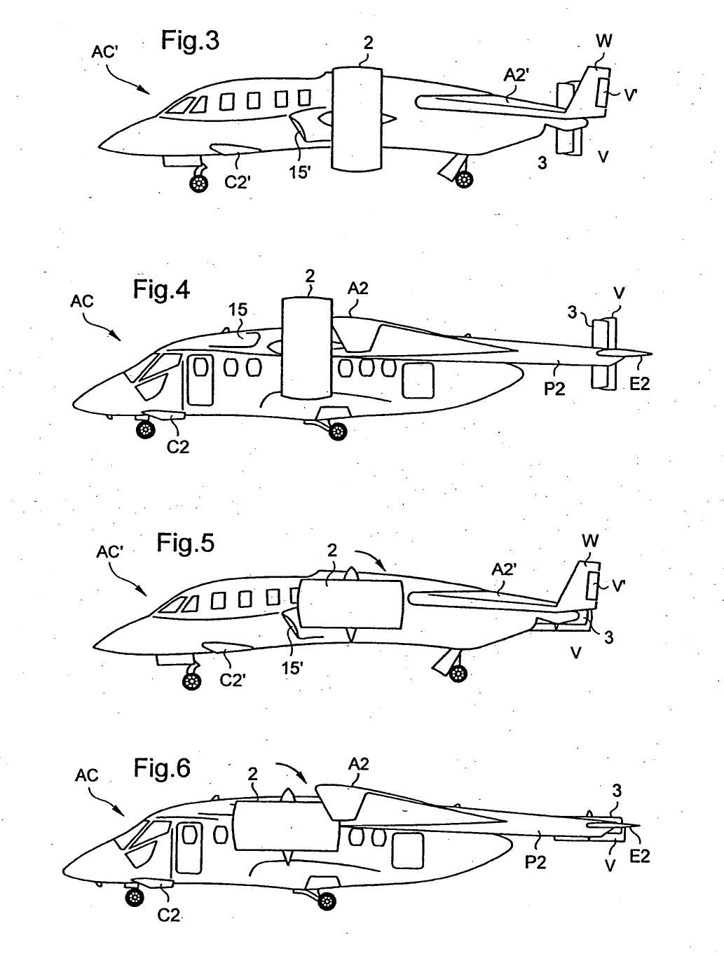

With reference to FIGS. 3 and 4, in airplane mode, the first, second, and third tilt fans 1, 2, and 3 are in the vertical position, and thus behave like propellers, thereby propelling the aircraft AC, AC′.

With reference to FIGS. 5 and 6, in helicopter mode, the first, second, and third tilt fans 1, 2, and 3 are in a substantially horizontal position, thus serving to support the aircraft AC, AC′. As a result, the first, second, and third tilt fans 1, 2, and 3 tilt in a clockwise direction as represented by an arrow in FIGS. 5 and 6.

By way of example, there follows a description of how the convertible aircraft performs a short or vertical landing.

In order to perform a short landing, the first, second, and third tilt fans 1, 2, and 3 are in the vertical position. The main wings A1, A2, A1′, A2′ are in the slipstreams from the first and second tilt fans 1 and 2. The double-slotted high-lift flaps VF1, VF2, VF1′, VF2′ serve to deflect the slipstreams from the tilt fans downwards, thereby significantly increasing the lift provided by the main wings A1, A2, A1′, A2′. This delays stalling of the main wings A1, A2, A1′, A2′. Under such conditions, the approach speed is slow, which implies that the distance needed for landing is very short.

The convertible aircraft AC, AC′ is also capable of landing vertically. Under such circumstances, it begins by converting from airplane mode to helicopter mode by progressively tilting the first, second, and third tilt fans 1, 2, and 3. Once these tilt fans 1, 2, and 3 are in the horizontal position, they support the aircraft AC, AC′. The aircraft then operates like a helicopter and can land vertically.

The attitude of the convertible aircraft can be trimmed in airplane mode in various ways. A first solution consists in using two “canard” wings and winglets provided with control surfaces, a second solution uses two “canard” wings, a substantially horizontal tail stabilizer, and a tail fin. Which embodiment to use depends on where the engines are centered, on the payload, and on the type of the aircraft, i.e. whether it is a light aircraft (mass less than about 6 tonnes) or a heavy aircraft (mass greater than about 6 tonnes).

With reference to FIG. 1, the engine installation is situated behind the cabin, with the cabin occupying only part of the fuselage. Balancing the aircraft requires main wings A1′, A2′ to be used that are sweptback, i.e. that are swept towards the rear of the aircraft.

The end of each of these wings A1′, A2′ is provided with a vertical element known as a winglet W.

These winglets W are in widespread use on modern airplanes. They reduce the pressure difference between the top and bottom faces of a main wing so as to reduce the marginal vortex that is of a turbulent nature. As a result winglets W improve the level of vibration in the aircraft. In addition they increase the main wing aspect ratio, thereby reducing drag.

Furthermore, for the light convertible aircraft AC′ of the invention, the main wings A1′, A2′ are well towards the rear of the fuselage and they have considerable sweep back. Each winglet W then serves as a tail fin, and is provided with a second flap V′ acting as a rudder.

The position of the main wings A1′, A2′ on the fuselage F′ is of major importance. Main wings in the high position, i.e. arranged at the top of the fuselage, and main wings in the low position, i.e. arranged at the bottom of the fuselage, do not have the same impact on the way the aircraft operates. When going from airplane mode to helicopter mode, the first, second, and third tilt fans 1, 2, and 3 are tilted so as to direct their thrust towards the ground. The time during which the main wings A1′, A2′ are exposed to the inclined slipstreams coming from the first and second tilt fans 1 and 2 must be minimized so as to avoid disturbing operation of the aircraft.

With main wings in low position, the slipstreams coming from the first and second tilt fans 1 and 2 strike the top surfaces of the main wings A1′, A2′. Consequently, the lift provided by the wings A1′, A2′ decreases, which can lead to a major safety problem, i.e. loss of control of the aircraft AC′. Under such conditions, only a high position for the main wings A1′, A2′ can satisfy requirements.

With reference to FIG. 2, in the second embodiment, the convertible aircraft AC is of considerable weight. The engine installation is positioned in the top portion of the fuselage F above the cabin. This disposition thus enables the cabin to occupy the major fraction of the fuselage F and thus provides a convertible aircraft AC having large internal carrying capacity.

Balancing the aircraft thus requires main wings A1, A2 to be used that are sweptforward, i.e. directed towards the front of the aircraft. The use of sweptback main wings, in this embodiment, would result in the “canard” wings C1, C2 being overdimensioned which would be particularly penalizing in terms of weight.

Furthermore, the first flap V arranged on the third tilt fan acts as a tail fin, thus enabling the aircraft AC to be controlled in yaw.

In addition, to avoid any loss of control of the convertible aircraft AC when passing from airplane mode to helicopter mode, the main wings A1, A2 are arranged on the fuselage F in the high position.

In addition, conventional stabilizers comprising first and second substantially horizontal stabilizers E1 and E2 arranged respectively on the first and second tail booms P1 and P2 improve pitch control of the aircraft.

Naturally, the present invention is capable of numerous variations as to how it is implemented. Although two embodiments are described above, it will be readily understood that it not conceivable to identify exhaustively all possible embodiments. Naturally, it is possible to envisage replacing any of the means described by equivalent means, without thereby going beyond the ambit of the present invention.

1. A convertible aircraft provided with first and second tail booms and with first and second tilt fans disposed on either side of its fuselage a little forward of the center of gravity of said aircraft, the aircraft including a third tilt fan arranged between said first and second tail booms.

2. A convertible aircraft according to claim 1, the aircraft being provided with “canard” wings.

3. A convertible aircraft according to claim 1, having two engines for driving said first, second, and third tilt fans.

4. A convertible aircraft according to claim 3, wherein the exhaust gases from said engines are exhausted from the top of said fuselage via two openings.

5. A convertible aircraft according to claim 1, wherein said third tilt fan is provided with a first flap.

6. A convertible aircraft according to claim 3, wherein said engines are inserted in the fuselage behind the cabin of said convertible aircraft.

7. A convertible aircraft according to claim 6, wherein said convertible aircraft is provided with two main wings disposed on either side of the fuselage, and said main wings are sweptback.

8. A convertible aircraft according to claim 7, wherein the end of each of said main wings is provided with a winglet.

9. A convertible aircraft according to claim 8, wherein said winglet includes a second flap.

10. A convertible aircraft according to claim 6, wherein two distinct air inlets situated respectively on the sides of the fuselage feed fresh air to said engines.

11. A convertible aircraft according to claim 7, wherein said main wings of said convertible aircraft are in the high position.

12. A convertible aircraft according to claim 7, wherein said main wings are provided with double-slotted high-lift flaps.

13. A convertible aircraft according to claim 3, wherein said engines are inserted in the fuselage above the cabin of said convertible aircraft.

14. A convertible aircraft according to claim 13, wherein a first substantially horizontal stabilizer is arranged on said first tail boom.

15. A convertible aircraft according to claim 14, wherein a second substantially horizontal stabilizer is arranged on said second tail boom.

16. A convertible aircraft according to claim 13, having two main wings which are sweptforward and which are disposed on either side of said fuselage.

17. A convertible aircraft according to claim 13, wherein two distinct air inlets, situated on the top of the fuselage, feed fresh air to said engines.

18. A convertible aircraft according to claim 16, wherein said main wings of said convertible aircraft are in the high position.

19. A convertible aircraft according to claim 16, wherein said main wings are provided with double-slotted high-lift flaps.
